(19) United States
(12) Patent Application Publication
(10) Pub. No.: US 2007/0138023 A1
(43) Pub. Date: Jun. 21, 2007

(54) Combined electrochemical machining and electropolishing micro-machining apparatus and method

(76) Inventors: Shuo-Jen Lee, Taipei City (TW); Jian-Jang Lai, Hsinchu City (TW); Yu-Ming Lee, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/486,015

(22) Filed: Jul. 14, 2006

(30) Foreign Application Priority Data
Dec. 19, 2005 (TW) 094145114

(51) Int. Cl. B23H 5/02

(52) U.S. Cl. 205/652

(57) ABSTRACT

A combined electrochemical machining and electropolishing micro-machining method includes the steps of (1) preparing step, (2) first-stage processing step, (3) second-stage processing step, and (4) finishing step. The apparatus includes an electrochemical machining solution container, an electropolishing solution container, a metal workpiece connecting with an anode, a mold-plate portion connecting with a cathode. Based on this arrangement, the metal workpiece is immersed in a first working fluid to conduct the electrochemical machining process and then to be immersed in a second working fluid to conduct the electropolishing process. So, the overall micro-machining speed is fast. It can improve the surface roughness significantly. It is suitable for extremely hard metal workpiece.

### BACKGROUND OF INVENTION

1. Field of the Invention

The present invention relates to a combined electrochemical machining and electropolishing micro-machining apparatus and method. The overall micro-machining speed is fast. It can improve the surface roughness significantly. It is suitable for extremely hard metal workpiece.

2. Description of the Prior Art

The traditional machining methods include lathe, mill, plane, grind, drill, etc. However, when a micro-machining is needed, the electroforming method is another possible machining method. No matter which kind of machining method is utilized, the traditional methods still have the following disadvantages and problems.

[1] The overall machining speed is relative slow. As the need for micro-machining increases in recent years, the electroforming method is a possible solution. But, its machining speed is very slow. So, it is not suitable for most mass production and for various products.

[2] The surface roughness is poor. When the lathing, milling, planing, grinding, or drilling is used for machining, generally its working speed is faster. But, it is easy to create pressure, heat, deformation and/or residual stress problems. Moreover, after such machining, the surface roughness is poor. In addition, cooling, debris removing and tool wearing are other major issues need to be solved. In case it is for micro-machining, the available tools become less and difficult to find. Under some conditions, it might happen that there is no tool can be used for micro-machining.

[3] It cannot work on an extremely hard metal workpiece. By using a tool, although the traditional directly-contacting machining speed is fast, it causes the tool wearing problem. For some extremely-hard metal workpiece, it is possible that no tool can be used.

### SUMMARY OF THE INVENTION

The primary object of the present invention is to provide a combined electrochemical machining and electropolishing micro-machining apparatus and method. In which, its overall micro-machining speed is fast.

The next object of the present invention is to provide a combined electrochemical machining and electropolishing micro-machining apparatus and method. It can improve the surface roughness significantly.

Another object of the present invention is to provide a combined electrochemical machining and electropolishing micro-machining apparatus and method. It is suitable for extremely hard metal workpiece.

In order to achieve the above-mentioned objects, a technical solution is provided. A combined electrochemical machining and electropolishing micro-machining apparatus comprising:

an electrochemical machining solution container for storing a first working fluid, said first working fluid being a neutral solution containing water and salt substance;

an electropolishing solution container for storing a second working fluid, said second working fluid being an acid solution containing water and acid substance;

a power supplying system having an anode and a cathode;

a metal workpiece holder for securing a metal workpiece, said metal workpiece connecting with said anode; and

a mold-plate assembly having a micro-movement controller and a mold-plate portion, said mold-plate portion connecting with said cathode;

wherein said metal workpiece and said mold-plate portion are immersed in said first working fluid to conduct a first-stage processing and then said metal workpiece and said mold-plate portion are immersed in said second working fluid to conduct a second-stage processing.

In addition, concerning the method of this invention, a combined electrochemical machining and electropolishing micro-machining method comprises the following steps:

(1) preparing step;

(2) first-stage processing step;

(3) second-stage processing step; and

(4) finishing step.

### BRIEF DESCRIPTION OF THE DRAWINGS

FIG. 1 is a perspective view of the present invention.

FIG. 2 is an enlarged cross-sectional view of a selected portion of the present invention.

FIG. 3A illustrates the electrochemical machining process of this invention.

FIG. 3B shows the electropolishing process of this invention.

FIGS. 4A, 4B, 4C and 4D show the detailed processes regarding the electrochemical machining process in this invention.

FIG. 5 is a flow chart about the micro-machining method of the present invention.

FIGS. 6A, 6B and 6C exhibit the principle of the electrochemical machining process in the present invention.

FIGS. 7A, 7B and 7C show the detailed processes regarding the electropolishing process in the present invention.

### DETAILED DESCRIPTION OF THE PREFERRED EMBODIMENT

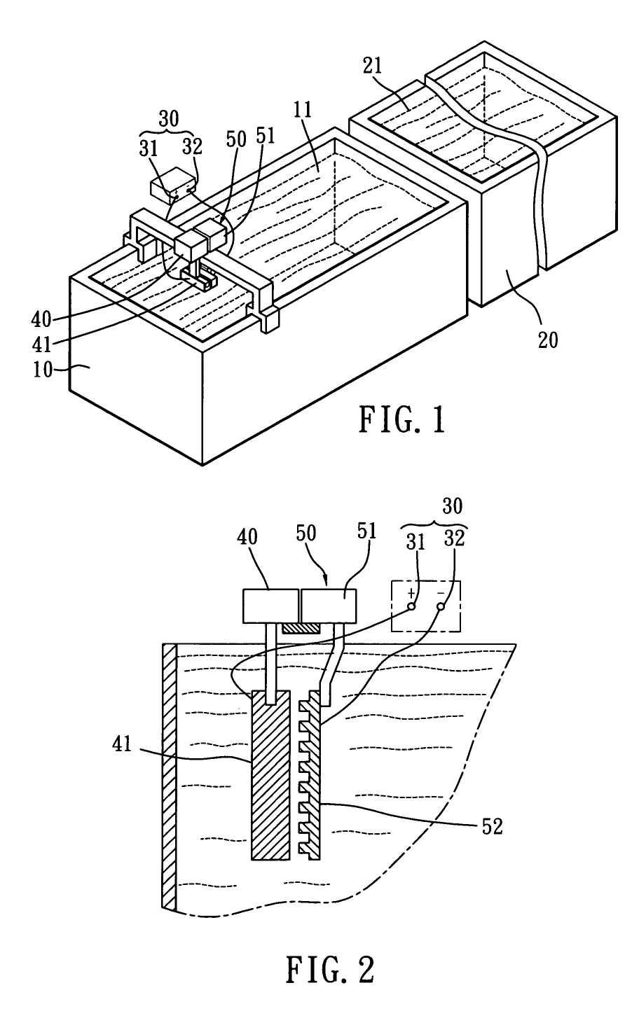

Referring to FIGS. 1 and 2, the present invention relates a combined electrochemical machining and electropolishing micro-machining apparatus. It comprises:

an electrochemical machining solution container 10 for storing a first working fluid 11; the first working fluid 11 being a neutral solution 11 containing water and salt substance;

an electropolishing solution container 20 for storing a second working fluid 21; the second working fluid 21 being an acid solution containing water and acid substance;

a power supplying system 30 having an anode 31 and a cathode 32;

a metal workpiece holder 40 for securing a metal workpiece 41; the metal workpiece 41 connecting with the anode 31; and

a mold-plate assembly 50 having:
(a) a micro-movement controller 51; and
(b) a mold-plate portion 52; the mold-plate portion 52 connecting with the cathode 32 and being driven by the micro-movement controller 51;

so that the metal workpiece 41 and the mold-plate portion 52 are immersed in the first working fluid 11 to conduct a first-stage processing (in this invention, it is the electrochemical machining process) and then the metal workpiece 41 and the mold-plate portion 52 are immersed in the second working fluid 21 to conduct a second-stage processing (in this invention, it is the electropolishing process).

Practically, the electrochemical machining solution container 10 and the electropolishing solution container 20 are two separated fluid containers.

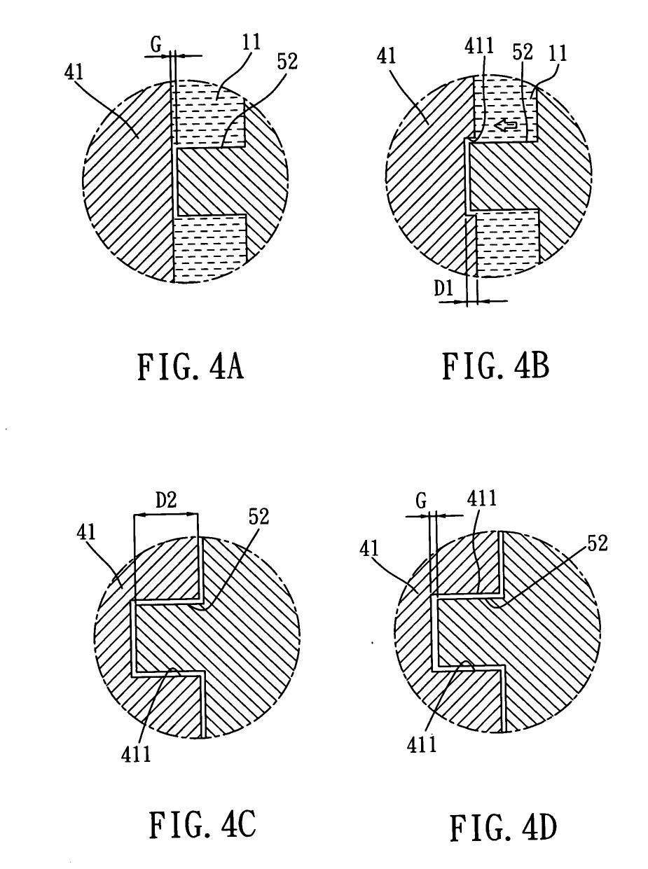

The micro-movement controller 51 controls the mold-plate portion 52 to move toward the metal workpiece 41 and to keep a predetermined working gap G between the metal workpiece 41 and the mold-plate portion 52 (as shown in FIG. 4B).

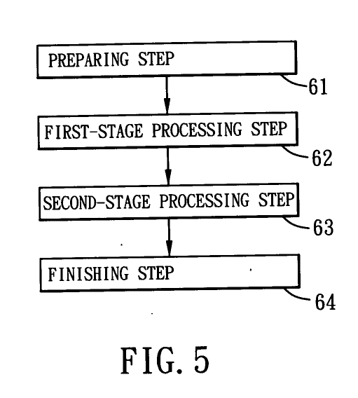

As illustrated in FIGS. 1 and 5, about the method in this invention, the combined electrochemical machining and electropolishing micro-machining method comprises the following steps:

(1) Preparing step 61: to prepare an electrochemical machining solution container 10, an electropolishing solution container 20, a power supplying system 30, a metal workpiece holder 40, and a mold-plate assembly 50; in which, the electrochemical machining solution container 10 providing a first working fluid 11, the first working fluid 11 being a neutral solution containing water and salt substance; the electropolishing solution container 20 providing a second working fluid 21, the second working fluid 21 being an acid solution containing water and acid substance; the power supplying system 30 having an anode 31 and a cathode 32; the metal workpiece holder 40 being used for securing a metal workpiece 41, the metal workpiece 41 connecting with the anode 31; the mold-plate assembly 50 having a micro-movement controller 51 and a mold-plate portion 52, the mold-plate portion 52 connecting with the cathode 32.

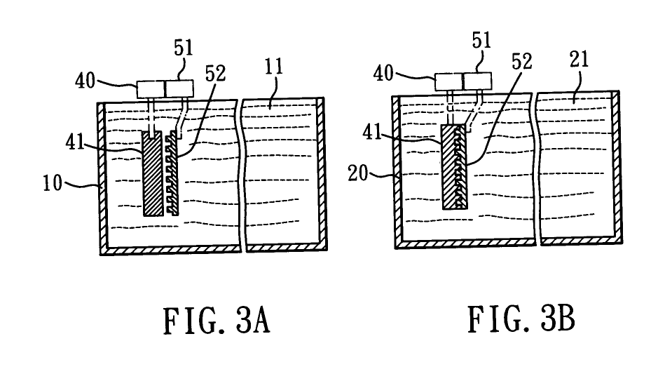

(2) The first-stage processing step 62: as shown in FIG. 3A, the metal workpiece 41 and the mold-plate portion 52 are immersed in the first working fluid 11 (in the electrochemical machining solution container 10) to conduct a first-stage processing. Turn on the power supplying system 30. By this anode 31, let the metal workpiece 41 carrying the positive electricity. By this cathode 32, let the mold-plate portion 52 carrying with the negative electricity. Meanwhile, in cooperating with the first working fluid 11, the metal workpiece 41 gradually forms a predetermined shape in the first-stage processing step (in this invention, it is the electrochemical machining process).

(3) Second-stage processing step 63: as illustrated in FIG. 3B, the metal workpiece 41 and the mold-plate portion 52 are immersed in the second working fluid 21 (in the electropolishing solution container 20) to conduct a second-stage processing. Turn on the power supplying system 30 and the micro-movement controller 51. By this anode 31, this metal workpiece 41 will carry the positive electricity. By this cathode 32, this metal workpiece 41 will carry the negative electricity. In addition, the micro-movement controller 51 drives the metal-plate portion 52 to move forward the metal workpiece 41. Meanwhile, in cooperating with the second working fluid 21, the metal workpiece 41 will be well-polished to a predetermined condition in the second-stage processing step (in this invention, it is the electropolishing process).

(4) Finishing step 64: a surface of the metal workpiece 41 will be formed corresponding to the preset shape of the mold-plate portion 52 and then a final product will be obtained.

Furthermore, in the first-stage processing step 61, the initial condition is shown as FIGS. 3A and 4A. Both the metal workpiece 41 and the mold-plate portion 52 are immersed in the first working fluid 11. And, there is a working gap G. Then, turn on the power supply system 40, the mold-plate 52 gradually moves toward the workpiece 41 and then a shallower recess 411 (as shown in FIG. 4B) on the workpiece 41 is gradually formed. The shallower recess 411 has a first depth D1. The moving speed can be controlled by the micro-movement controller 51.

After working a period of time, the mold-plate 52 still gradually moves toward the workpiece 41 and then a deeper recess 411 (as shown in FIG. 4B) on the workpiece 41 is gradually formed. This deeper recess 411 has a second depth D2 (as shown in FIG. 4C). Please note that it utilizes the electrochemical machining process in the first-stage processing step 61.

With regard to the second-stage processing step 62, both the metal workpiece 41 and the mold-plate portion 52 are immersed in the second working fluid 21. The manufacturing apparatus is set up as illustrated in FIG. 3B. At this moment, the mold-plate portion 52 and the metal workpiece 41 are kept spaced apart with the working gap G (see FIG. 4C). Then, start the electropolishing process (as shown in FIG. 4D). By doing so, the surface of this deeper recess 411 can be well-polished and its roughness can be significantly improved.

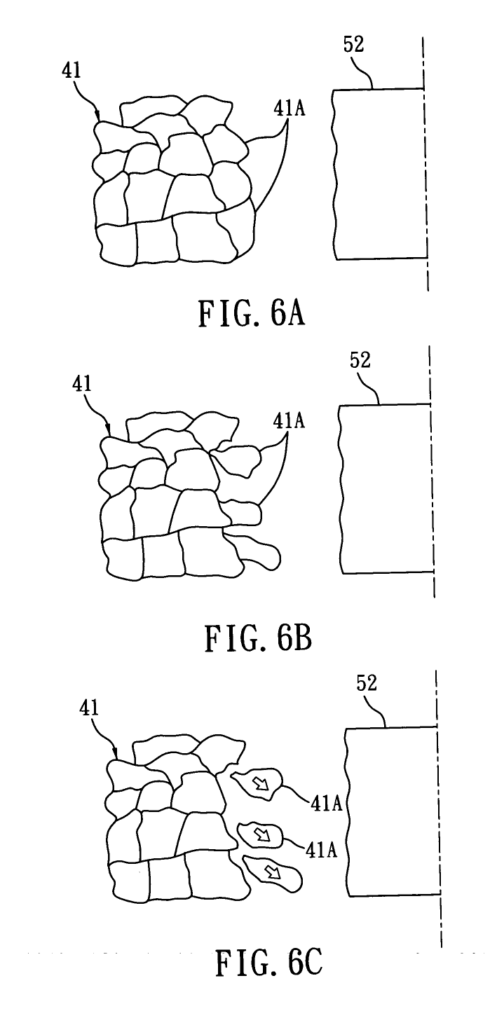

Furthermore, FIGS. 6A, 6B, and 6C exhibit the principle of the electrochemical machining process. At the beginning, the metal grains 41A of the metal workpiece 41 are tightly bonded together (as shown in FIG. 6A). Gradually, the metal grains 41A of the metal workpiece 41 are gradually loosened and break down from their weakest boundaries (as shown in FIG. 6B). Finally, the outermost metal grains 41A will gradually separate (or peel off) as shown in FIG. 6C. Although this kind of process is faster, the surface roughness is very poor.

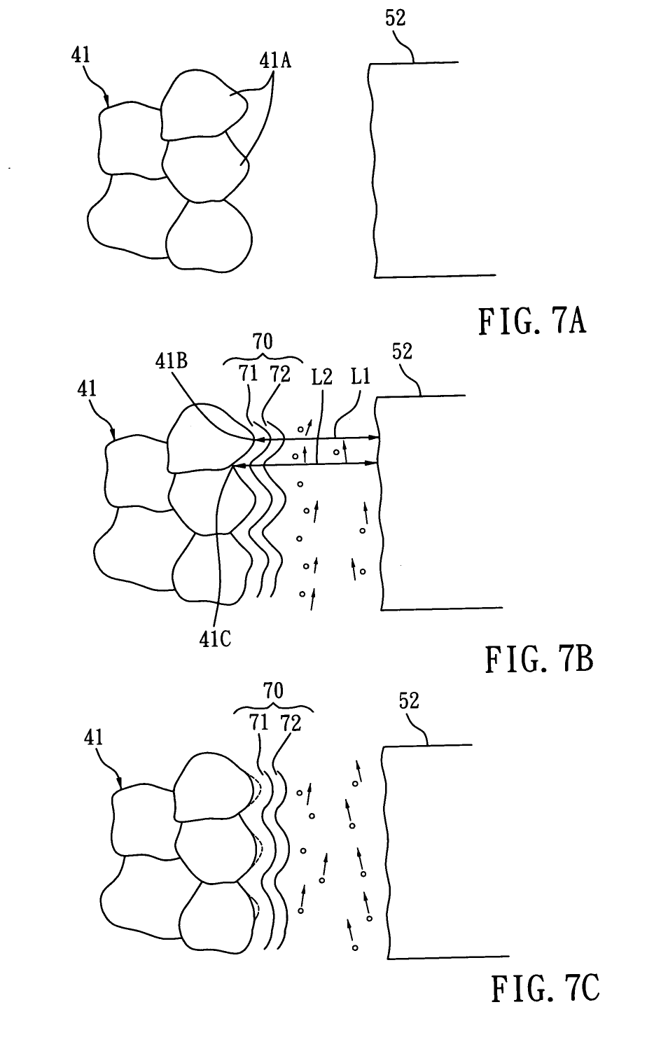

Next, concerning the principle of the eletropolishing process, it can be seen in FIGS. 7A, 7B, and 7C. Regarding the metal grains 41A of the metal workpiece 41, after finishing the electrochemical machining process, they are moved to the electropolishing solution container 20 and immersed in the second working fluid 21 (as shown in FIGS. 3B and 7A). Start the electropolishing process. Since the second working fluid 21 contains water and acid substance. As illustrated in FIG. 7B, a viscous layer 70 (or called oxide film) is gradually formed. The viscous layer 71 includes an inner viscous layer 71 with higher viscosity and an outer viscous layer 72 with lower viscosity. At this time, the metal grains 41A carry the positive electricity so the hydrogen gas (or small bubbles) is generated. Also, the mold-plate portion 52 carries the negative electricity so the oxygen gas (or small bubbles) is generated. It is a typical reverse electroplating reaction.

According to the FIG. 7B, there is a first distance L1 between a protrusion 41B of the metal workpiece 41 and the mold-plate portion 52. Also, there is a second distance L2 between a cavity 41C of the metal workpiece 41 and the mold-plate portion 52. Because the first distance L1 is shorter than the second distance L2, the electric filed intensity at the place of the first distance L1 is larger than the one at the place of the second distance L2. Therefore, the protrusion 41B (or protrusions 41B) will be removed first (as illustrated in FIG. 7C). Hence, although the removing speed is relative slow, it still can improve the surface roughness significantly.

The advantages and functions of the present invention can be summarized as follows.

[1] The overall micro-machining speed is fast. In this invention, it utilities two different types of machining methods combining the electrochemical machining process and the electropolishing process. In the first-stage processing step, its machining speed is faster, so it can quickly manufacture a desired shape. That is, a proximate shape can be obtained quickly.

[2] It can improve the surface roughness significantly. In the second-stage processing step of this invention, it utilizes the electropolishing technology. By the principle that shorter distance has larger electric filed intensity, the protrusions of metal grains of the metal workpiece will be removed first. Thus, It can improve the surface roughness significantly.

[3] It is suitable for extremely hard metal workpiece. This invention uses the non-contact machining method. Even though the hardness of the metal workpiece is very high, this invention still can work well.

The above embodiments are only used to illustrate the present invention, not intended to limit the scope thereof. Many modifications of the above embodiments can be made without departing from the spirit of the present invention.

What is claimed is:

1. A combined electrochemical machining and electropolishing micro-machining apparatus comprising:
an electrochemical machining solution container for storing a first working fluid, said first working fluid being a neutral solution containing water and salt substance;
an electropolishing solution container for storing a second working fluid, said second working fluid being an acid solution containing water and acid substance;
a power supplying system having an anode and a cathode;
a metal workpiece holder for securing a metal workpiece, said metal workpiece connecting with said anode; and
a mold-plate assembly having a micro-movement controller and a mold-plate portion, said mold-plate portion connecting with said cathode;
wherein said metal workpiece and said mold-plate portion are immersed in said first working fluid to conduct a first-stage processing and then said metal workpiece and said mold-plate portion are immersed in said second working fluid to conduct a second-stage processing.

2. The combined electrochemical machining and electropolishing micro-machining apparatus as claimed in claim 1, wherein
said electrochemical machining solution container and said electropolishing solution container are two separated fluid containers;
said first-stage processing conducts an electrochemical machining process; and
said second-stage processing conducts an electropolishing process.

3. The combined electrochemical machining and electropolishing micro-machining apparatus as claimed in claim 1, wherein
said micro-movement controller controls said mold-plate portion to move toward said metal workpiece and to keep a predetermined working gap between said metal workpiece and said mold-plate portion.

4. A combined electrochemical machining and electropolishing micro-machining method comprising the steps of:
(1) preparing step: to prepare an electrochemical machining solution container, an electropolishing solution container, a power supplying system, a metal workpiece holder, and a mold-plate assembly; said electrochemical machining solution container providing a first working fluid, said first working fluid being a neutral solution containing water and salt substance; said electropolishing solution container providing a second working fluid, said second working fluid being an acid solution containing water and acid substance; said power supplying system having an anode and a cathode; a metal workpiece holder for securing a metal workpiece, said metal workpiece connecting with said anode; said mold-plate assembly having a micro-movement controller and a mold-plate portion, said mold-plate portion connecting with said cathode;
(2) first-stage processing step: said metal workpiece and said mold-plate portion being immersed in said first working fluid to conduct a first-stage processing;
(3) second-stage processing step: said metal workpiece and said mold-plate portion being immersed in said second working fluid to conduct a second-stage processing;
(4) finishing step: a surface of said metal workpiece being formed corresponding to a shape of said mold-plate portion and then a final product being obtained.

5. The combined electrochemical machining and electropolishing micro-machining method as claimed in claim 4, wherein
said electrochemical machining solution container and said electropolishing solution container are two separated fluid containers;
said first-stage processing conducts an electrochemical machining process;
said second-stage processing conducts an electropolishing process; and
said micro-movement controller controls said mold-plate to move toward said metal workpiece and to keep a predetermined working gap between said metal workpiece and said mold-plate portion.
